(19) United States
(12) Patent Application Publication
(10) Pub. No.: US 2026/0319744 A1
(43) Pub. Date: Oct. 15, 2026

(54) BLOCK NORMALIZATION OF FP8 DOT PRODUCTS

(71) Applicant: ADVANCED MICRO DEVICES, INC., Santa Clara, CA (US)

(72) Inventors: Eric Mark Schwarz, Fishkill, NY (US); Stuart David Simpson Biles, Bury St. Edmunds (GB); Michael Estlick, Fort Collins, CO (US); Naveen Kumar Mellempudi, Leander, TX (US); Glendon Leo Akins, III, Fort Collins, CO (US); Douglas John Cutter, Fort Collins, CO (US); Mahadev Deshpande, Fort Collins, CO (US); Brian William Thompto, Austin, TX (US)

(21) Appl. No.: 19/465,679

(22) Filed: Jan. 30, 2026

Related U.S. Application Data
(60) Provisional application No. 63/752,095, filed on Jan. 31, 2025.
(60) Provisional application No. 63/752,266, filed on Jan. 31, 2025.
(60) Provisional application No. 63/771,551, filed on Mar. 13, 2025.

(51) Int. Cl. G06F 7/544; G06F 5/01

(52) U.S. Cl. CPC G06F 7/5443; G06F 5/012

(57) ABSTRACT

Techniques are provided for generating fused dot product results across multiple operand formats using a shared hardware datapath. A plurality of partial products is generated based on input operands and analyzed to determine a maximum product exponent. Each product term is shifted based on the difference between its exponent and the maximum, then modified through one or more operations such as compression, normalization, conditional complementing, or truncation to produce an intermediate dot product result. The intermediate result is aligned and summed with a secondary operand, such as a prior accumulation or bias, to generate a fused dot product output. The architecture supports format-specific operand paths for differently formatted input operands, and consolidates results through a shared accumulation datapath.

### BACKGROUND

Floating-point arithmetic plays a large role in a wide range of computational workloads, including in the domains of machine learning, signal processing, and scientific computing. To improve performance and reduce resource demands, modern processors and instruction set architectures increasingly support low-precision formats, such as 8-bit floating-point (FP8) format, which offer a compact alternative to traditional formats like 16-bit floating-point (FP16) and 32-bit floating-point (FP32).

Dot product operations, which perform a summation of elementwise products across corresponding vector elements, are a foundational primitive in these and other domains. In the context of FP8, such operations typically involve a multiplication of multiple FP8 operand pairs, followed by accumulation into a higher-precision result format such as FP32. These FP8 dot products are often implemented as fused operations (in which multiple arithmetic steps are performed as a single, combined unit of execution without separately rounding intermediate results) to maximize computational density and minimize latency.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system utilizing at least one CPU configured to execute instructions for one or more applications represented by instructions and other data stored in one or more system memories, in accordance with some embodiments.

FIG. 2 illustrates exponent alignment and normalization logic for a block-normalized dot product operation, in accordance with various embodiments.

FIG. 3 illustrates an exponent selection pipeline for determining a maximum corrected exponent across multiple multiplicative terms, in accordance with various embodiments.

FIG. 4 illustrates a processing pipeline for block-normalized dot product accumulation, in accordance with various embodiments.

FIG. 5 illustrates a processing pipeline configured to perform fused dot product computations using multiple alternative operand format paths, in accordance with various embodiments.

FIG. 6 illustrates an operational flow diagram representing a fused dot product routine implemented by a processing system, in accordance with various embodiments.

### DETAILED DESCRIPTION

While FP8 multiplication is comparatively lightweight, the summation of multiple FP8 products presents challenges due to the wide dynamic range of possible intermediate values and the need to preserve numerical precision. The summation process becomes particularly sensitive when operand values vary widely in magnitude, as can occur in common inference workloads. In some cases, cancellation effects between high-magnitude terms can obscure or eliminate lower-magnitude contributions unless sufficient bit-width and normalization are employed.

Conventional approaches have addressed this problem using large internal accumulator paths or extended integer representations to exactly represent intermediate values. However, these solutions often incur significant area costs or increased power consumption. As processor designs evolve to support dense, high-throughput matrix operations using compact data types, there remains a need for improved accumulation techniques that balance numerical fidelity with implementation efficiency.

Embodiments of techniques described herein provide hardware-implemented dataflow structures and processing logic for performing low-precision floating-point dot product operations using block normalization. In some embodiments, such techniques improve the underlying computing system by enabling accumulation of multiple FP8 products with enhanced numerical stability and reduced circuit area, such as by employing exponent-aligned intermediate summation within a fixed-width datapath. These techniques support efficient integration of low-precision operands and higher-precision accumulation terms while minimizing rounding artifacts and preserving significant bit coverage across a wide dynamic range.

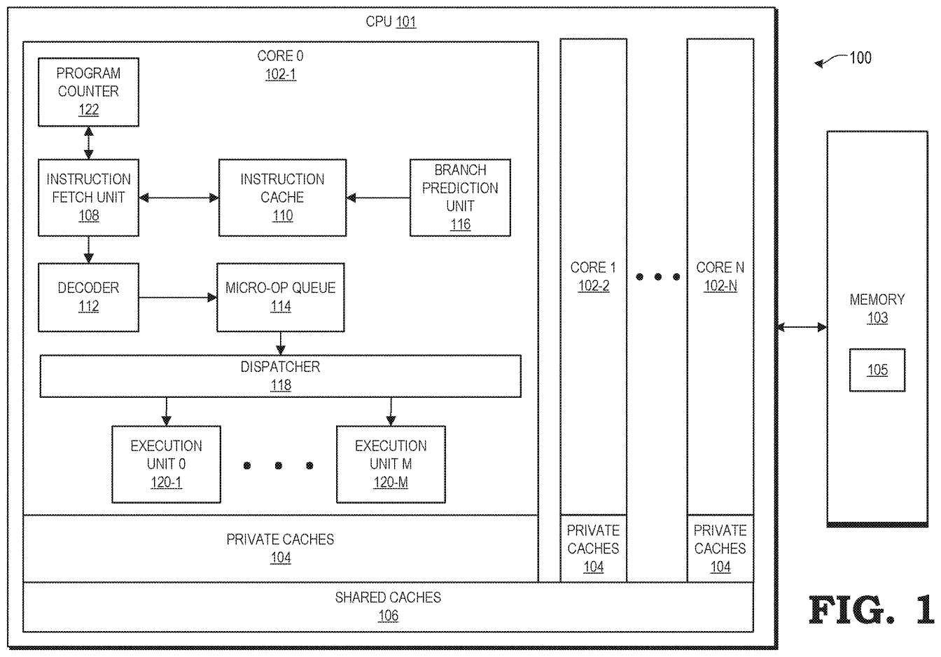

FIG. 1 illustrates a processing system 100 utilizing at least one CPU 101 configured to execute instructions for one or more applications represented by instructions and other data stored in one or more system memories 103 in accordance with some embodiments. To execute these applications, the CPU 101 includes an architecture having one or more processor cores 102, each associated with one or more private caches 104 and one or more shared caches 106. These private caches 104 each include a volatile memory, non-volatile memory, or both included in or otherwise connected (e.g., by a data fabric or bus) to a processor core 102 and are each only accessible by a corresponding processor core 102.

As an example, CPU 101 includes a respective first private cache (e.g., L0 cache), and a respective second private cache 104 (e.g., L1 cache) that are included in or otherwise connected to a corresponding processor core 102 such that they are each only accessible by the corresponding processor core 102. Additionally, the shared caches 106 each include a volatile memory, non-volatile memory, or both and are each connected (e.g., by a data fabric or bus) to and accessible by two or more processor cores 102. For example, CPU 101 includes a last-level cache (e.g., L3 cache) connected to and accessible by two or more processor cores (e.g., core 0 102-1, core 1 102-2, core N 102-N). Each of the private caches 104 and shared caches 106 are configured to store instructions to be executed by CPU 101, data (e.g., operands, values) used in the execution of the instructions, data resulting from the execution of one or more instructions, or any combination thereof. According to some implementations, for each processor core 102, the private caches 104, shared caches 106, and a system memory (e.g., random access memory (RAM)) accessible by the processor core 102 are arranged in a hierarchy based on the respective sizes of the caches and system memory.

In various embodiments, each execution element 120 is configured to accept partial operands (operand fragments) in multiple numeric formats, including FP8 (E4M3 and E5M2), BF16, and INT8, and to select an output format prior to operand decode and alignment so that timing for a downstream accumulation and FP32 add datapath is unchanged. In certain embodiments, a block scale register is implemented within the execution element 120 and read via a scale path that is decoupled from operand fetch, such that scale selection occurs prior to operand ingress and scale application does not alter the timing of the downstream datapath. As used herein, ‘MX’ refers to block-scaled operation for FP8 or INT8 in which per-block power-of-two scale factors are supplied by the block scale register. In some embodiments, scaling factors for two dimensions are independently selectable by immediate fields and combined as a single power-of-two factor, such that selecting exponent zero for both scales yields behavior equivalent to unscaled FP8 or INT8.

As used herein, a thread refers to a sequence of instructions that can be independently scheduled and executed by a processor core 102. A thread may represent the smallest unit of execution within a process and may operate in parallel with other threads within the same application or across multiple applications. In some embodiments, each processor core 102 may concurrently execute multiple threads, each with its own program counter, register state, and instruction flow, while sharing access to caches, memory, and execution resources. CPU 101 is configured to execute instructions (e.g., instructions 105 stored in system memory 103) of one or more threads based on the type of architecture (e.g., an instruction set architecture (ISA)) associated with CPU 101. For example, based on CPU 101 having a complex instruction set computer (CISC) instruction set architecture (e.g., x86 architecture), CPU 101 is configured to execute instructions from a CISC instruction set (e.g., x86 instruction set). Additionally, based on CPU 101 having a reduced instruction set compute (RISC) instruction set architecture (e.g., ARM instruction set architecture, AVR instruction set architecture), CPU 101 is configured to execute instructions from a RISC instruction set (e.g., ARM instruction set, AVR instruction set). To execute instructions from an instruction set for one or more threads, CPU 101 includes one or more processor cores 104 each including a program counter 122, instruction fetch unit 108, instruction cache 110, decoder 112, micro-op queue 114, branch prediction unit 116, dispatcher 118, and one or more execution units 120. In some embodiments, the one or more execution units 120 support low-precision arithmetic operations, such as 8-bit floating-point (FP8) dot products, including fused or block-normalized accumulation logic configured to operate within a fixed-width datapath. In implementations, each processor core 104 is configured to concurrently execute instructions for two or more threads. Though the example implementation presented in FIG. 1 shows CPU 101 as including three processor cores (102-1, 102-2, 102-N) representing an N number of processor cores 102, in other implementations, CPU 101 may include any number of processor cores 102 based on design choices.

The program counter 122 of a processor core 104 can include a register configured to sequentially store data (e.g., pointers) representing the memory addresses of instructions in one or more threads to be executed for an application. As an example, the program counter 122 stores data indicating the physical or virtual addresses of one or more instructions of a thread in the order in which the instructions are to be executed. Based on the memory addresses indicated in the program counter 122, the instruction fetch unit 108 of the processor core 102 fetches instructions from the instruction cache 110 to execute. This instruction cache 110, for example, includes at least a portion of a private cache 104 accessible by the processor core 102 arranged in a hierarchy with one or more other private caches 104, shared caches 106, and the system memory also accessible by the processor core 102. According to implementations, the instruction fetch unit 108 first requests an instruction at the memory address indicated by the program counter 122 from the instruction cache 110. Based on the instruction not being in the instruction cache 110, a controller of the instruction cache 110 then request the instruction from the cache at a next level of the hierarchy. The controllers of the caches then continue requesting the instruction in this way until the instruction is found in a cache or the instruction is requested from the system memory, at which point the instruction is provided to the instruction fetch unit 108. In some implementations, the processor core 102 is configured to prefetch one or more instructions to be performed for the thread into one or more caches, such as instruction cache 110.

After the instruction fetch unit 108 has retrieved the instruction indicated by the program counter 122, the instruction fetch unit 108 provides the instruction to decoder 112 and increments the program counter 122 so as to indicate the next instruction to be executed. As an example, after retrieving an instruction, instruction fetch unit 108 stores the instruction in an instruction register included in or otherwise connected to decoder 112. The decoder 112 includes circuitry configured to decode the instruction to determine the operation code (“op-code”) of the instruction, one or more operands associated with the instruction, or both. For example, from the instruction, the decoder 112 determines op-code (e.g., micro op-code) indicating a type of instruction (e.g., load instruction, store instruction, ADD instruction, subtract instruction, branch instruction, conditional branch instruction, shift instruction) and which execution unit 120 is to execute the instruction. After decoding the instruction, the decoder 112 stores data indicating the op-code and operands of the instruction in a micro-op queue 114. This micro-op queue 114 includes one or more queues configured to store the decoded op-code (e.g., micro op-code) of instructions before the decoded op-code is provided to the execution engine 120 indicated by the op-code. According to some implementations, based on an instruction indicating a conditional branch instruction, branch prediction unit 116 is configured to predict one or more additional instructions. For example, from the conditional branch instruction, the branch prediction unit 116 determines a predicted branch (e.g., a branch predicted to be taken when the instruction is executed) and an unpredicted branch (e.g., a branch not predicted to be taken when the instruction is executed). Based on the predicted branch, branch prediction unit 116 then determines one or more additional instructions to be executed and, in implementations, instructs instruction fetch unit 108 to retrieve these additional instructions.

The data indicating the op-code and operands associated with the instruction is provided from the micro-op queue 114 to a dispatcher 118 that includes circuitry configured to route the data to the corresponding execution engine 120 indicated in the op-code. An execution engine 120 of the processor core 102 includes circuitry configured to execute the op-code indicated in the data provided by dispatcher 118. For example, an execution engine 120 includes a floating point unit, integer unit, or the like. Further, each execution engine 120 includes a renamer that includes circuitry configured to allocate one or more registers of the execution unit 120 to store the operands of the instructions. For example, the renamer translates architectural registers indicated by the op-code of the instruction to one or more physical registers of the execution unit 120. After renaming the registers associated with the instruction, scheduling circuitry (e.g., scheduling queues) of the execution engine 120 provides data representing operations to be performed for the instruction to one or more execution pipes. For example, based on the operands and type of instruction, the scheduling circuitry provides data representing the operations to be performed to corresponding execution pipes. Each of these execution pipes of an engine 120 includes circuitry configured to perform one or more respective operations indicated by the op-code associated with an instruction such as one or more arithmetic logic unit operations, address generation unit operations, floating point add operations, fused multiply-add operations, or the like. After an execution pipe has performed an operation for an instruction, the data resulting from the performance of the operation is stored in a private cache 104, shared cache 106, system memory 103, or any combination thereof accessible by the processor core 102.

As noted above, in implementations the system 100 is configured to execute instructions configured in accordance with at least one ISA and/or ISA extension. One such ISA is the aforementioned x86 ISA. The x86 ISA is a family of instruction sets primarily used by compute systems, such as processing system 100, utilizing central processing units (CPUs) (e.g., CPU 101) or similar processors from Intel Corp. and Advanced Micro Devices (AMD) Inc. The x86 ISA primarily is directed to CISC (Complex Instruction Set Computing), which means that its instruction set includes a large number of instructions, some of which are capable of performing multiple operations in a single instruction. In an x86 architecture, a processor uses a set of general-purpose registers to perform operations on data. These registers hold operands for operations and store intermediate results. The architecture also uses a stack for function calls and local variables, with the stack pointer keeping track of the top of the stack. PUSH and POP operations are used to manipulate the stack during program execution. An instruction pointer holds the address of the next instruction to be executed and is automatically updated as instructions are processed. Control flow instructions modify the value of the instruction pointer, allowing for conditional and unconditional jumps in the execution flow.

The x86 ISAs include a range of basic instruction types. Data movement instructions like MOV, PUSH, and POP are used to move data between registers, memory, and the stack. Arithmetic operations such as ADD, SUB, MUL, and DIV manipulate data in registers or memory. The architecture also supports control flow instructions, such as JMP (unconditional jump) and CALL (function call), as well as conditional jump instructions like JE (jump if equal) and JNE (jump if not equal), which rely on the processor's flags to determine whether to alter the flow of execution. Logical operations like AND, OR, XOR, and NOT are used to perform bitwise operations on data, while string operations like MOVSB (move string byte) and CMPSB (compare string byte) are designed to manipulate sequences of data. Additionally, system and interrupt instructions such as INT and IRET allow the processor to handle external events or internal errors by transferring control to interrupt service routines.

Over time, x86 processors have incorporated additional features, such as SIMD (Single Instruction, Multiple Data), which are accessed, instruction-wise, via ISA extensions to accelerate parallel computing tasks. Once such set of x86 ISA extensions includes AVX (Advanced Vector Extensions), which is generally directed to improving the performance of computationally demanding applications by enabling more efficient SIMD operations. AVX enhances the x86 instruction set by offering powerful vector operations that significantly boost performance in tasks such as scientific computing, video processing, machine learning, and cryptography, where parallel data processing is crucial. One of the primary features of AVX is its wide vector registers. AVX extends the width of vector registers to 256 bits, which allows each register to hold up to eight single-precision (32-bit) floating-point numbers or four double-precision (64-bit) floating-point numbers. This increased register width enables processors to handle more data per operation, improving overall throughput and making data processing much more efficient. Moreover, AVX is designed to leverage SIMD parallelism, which means that a single instruction can perform the same operation on multiple data elements simultaneously. This parallelism is particularly beneficial for tasks like matrix multiplication or large-scale data processing, as one instruction can process multiple pieces of data at once, greatly speeding up computation. Another feature of AVX is its optimization for floating-point calculations. The instruction set supports efficient operations such as addition, multiplication, and dot products on vectorized data, which are common in applications that rely heavily on floating-point computation, including 3D rendering, scientific simulations, and signal processing. Additionally, some versions of AVX support for Fused Multiply-Add (FMA) instructions, which allow a single instruction to multiply two numbers and then add the result to a third. This helps reduce the latency of calculations and improves precision, which is especially beneficial in areas like linear algebra and numerical simulations.

AVX also introduces new instructions that enhance performance, such as AVX-optimized arithmetic operations for floating-point vector calculations. Instructions like VADDPS and VMULPS perform vectorized addition and multiplication, respectively, while others, like VPERMILPS, allow for more complex operations like reordering elements in a vector. These new instructions enable processors to handle large datasets more efficiently with fewer clock cycles. Furthermore, AVX helps improve power efficiency by optimizing the use of processor pipelines, meaning that certain operations can be completed using less energy, which is critical for tasks requiring extensive computational power,

In some scenarios and embodiments, AVX functionality may be extended through instruction set extensions such as the Advanced Computation Extension (ACE), which introduces tile-level registers and operations designed to accelerate matrix-oriented workloads. As used herein, a tile register refers to a two-dimensional accumulator storage structure arranged in multiple rows and sized to receive partial sums generated by the execution units described herein. In some embodiments, a tile register stores FP32 and/or INT32 accumulator values across multiple rows to facilitate accumulation over vector-sourced operands while preserving a regular handoff into normalization and rounding stages. A block scale register refers to an associated storage that provides power-of-two scale values for one or more blocks of operand elements, the scale values being combined and applied to product terms prior to or during alignment and compression so that the subsequent normalization and rounding stages may proceed within a shared backend.

In various embodiments, such instruction set extensions interoperate with AVX vector registers and enable fused or block-based dot product computation using compact data types such as FP8. Additional matrix-related features and one or more corresponding ISA extensions provide higher compute density capabilities and to provide for operations to accelerate matrix math operations. These one or more extensions augment AVX and scalar code with various capabilities, including as non-limiting examples: ACE register state, including tile and block scale registers; data processing operations that consume AVX register input and operate on tile register state; data move operations to move data between ACE register state, AVX registers and memory; state and operations for system management. Such extensions provide for integration between AVX vectors and ACE tile registers, combining high compute density tile processing operations with the comprehensive data processing features of AVX.

In some implementations, ACE adds a tile register file, containing a number of two-dimensional tile registers, each being, for example, 512-bits wide by 16 rows, with each row equivalent in size to a single AVX-512 vector. Each tile register row has width of 512-bits and may be viewed as composed of a number of elements, dependent on the type of data being processed in the tile register. For example, support for 32-bit (FP32 or INT32) accumulator types may be provided, and thus each ACE tile register row is therefore equivalent to 16 32-bit elements. ACE also, in implementations, may provide a number of tile registers; the number implemented is architecture specific and discoverable in feature registers.

One set of AVX instructions is referred to as Vector Neural Network Instructions (VNN Instructions). VNN instructions and their associated data formats are configured to support neural network and machine learning programs and operations. For example, some machine learning applications utilize floating-point formats such as 8-bit floating-point (FP8) with two different encodings (E5M2 and E4M3). A common arithmetic operation for machine learning applications is a weighted summation called a dot-product operation. For FP8 a 4-way dot-product operation has the FP32 bit result=A3*B2+A2*B2+A1*B1+A0*B0+C where Ai and Bi are in FP8 format and C is in FP32 bit format. This type of operation is difficult to round correctly. Some implementations have implemented the operations in a serial fashion which is slow or have created large exact implementations. Disclosed herein are techniques and circuits for performing these operations accurately while consuming relatively little circuit area.

Adding more than 2 floating-point operands is difficult to do with only one rounding error. For the FP8 4-way dot product there are 5 operands to add, 4 products and an addend. FP8 products can range from 2\hat{ }31 to 2\hat{ }−32 which would require 64 bits to represent as an integer. Some systems exactly represent the full floating-point space as integers. For FP8 products, the systems employ 64 bits for the product and another 3 bits for overflow and 1 bit for the sign. For FP32 formats, 276 bits plus overflow bits are used. Some systems employ block normalization and maintain 37-bits for 32 products. Other systems use 24-bits for a 4-way dot product.

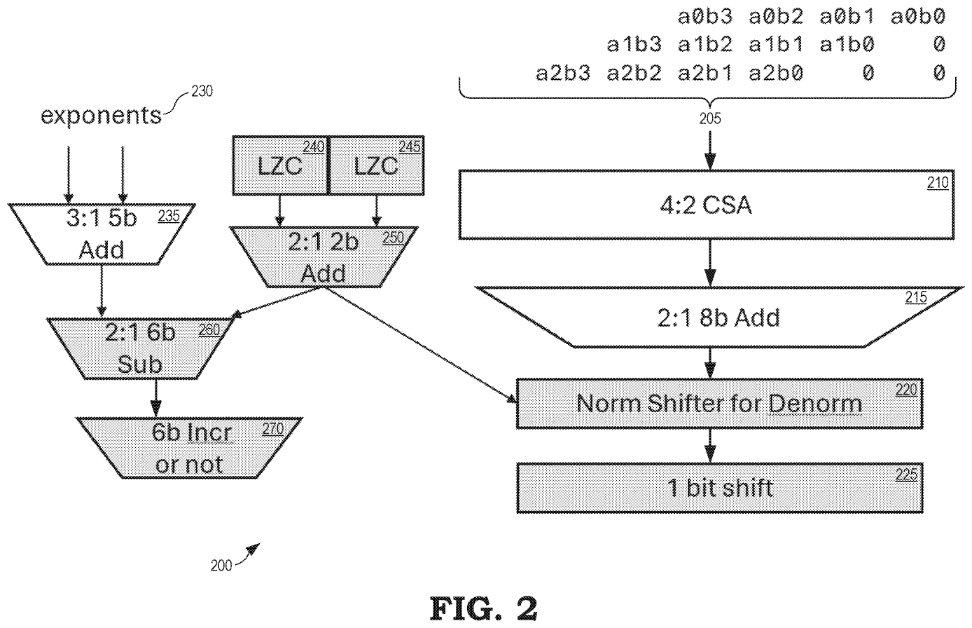

In some implementations, for the FP8 format, since the input operand widths are 32-bit wide, a processor implements a 32-bit wide block normalization. The processor adds the products separately from the addend. FP8 inputs are decoded into an internal superset representation that carries a sign, a five-bit exponent field corrected for denormal inputs, and an extended significand (also termed a mantissa) sufficient to preserve approximately twenty-nine significand bits (mantissa bits) together with overflow and sign when accumulated in carry-save form. Both FP8 encodings are ingested into this internal representation prior to exponent comparison and shift-distance computation (See FIGS. 2-4 elsewhere herein.) As used herein, a ‘denormal’ (also referred to as a ‘subnormal’) input is an encoded value (e.g., an FP8-encoded value) having an all-zero exponent field and a non-zero significand field, representing a magnitude smaller than the smallest normal value in the encoding. In such encodings the significand lacks an implicit leading 1. During decode, embodiments of techniques described herein correct denormal inputs by left-shifting the significand until a leading 1 is obtained and accounting for the applied shift in a correction to the effective exponent used for product-exponent derivation and alignment distances. Inputs with both an all-zero exponent field and a zero significand are treated as zeros and do not contribute to the product-sum; infinities and NaNs (special values used to represent results of undefined or unrepresentable operations) are handled according to the selected FPS encoding and are not denormals. The system thus employs 2-bits for overflow and 1-bit for sign, and employs the other 29-bits of width for the significand. Block-normalization utilizes the maximum product exponent. The processor calculates this exponent accurately and corrects for denormals. In some implementations, the processor zeroes the product exponent if an operand is zero but in other implementations the processor does not zero the product exponent.

Disclosed herein are implementations of a processor that implements a 32-bit wide dataflow to enhance the datapath width of the input and output operands. After shifting based on the maximum corrected product exponent, the processor maintains two overflow bits and one sign bit, and preserves approximately twenty-nine bits of significand across the four products. The processor determines the maximum product exponent after correcting for denormals and zeros. The processor sums, normalizes, and conditionally complements the products. The processor then truncates the result to 25-bits and aligns and sums the result to the addend. The processor rounds and normalizes the results of the sum. This approach provides good accuracy while consuming a relatively small amount of circuit area. In some implementations, the processor implements a 5-cycle pipeline with the last 2 cycles being a FP32 bit accumulation. This allows the addend to be pipelined every other cycle.

Examples of the above-described techniques are illustrated at FIGS. 2-6. As used herein with respect to such figures, a block refers to a hardware-defined functional unit comprising one or more circuits configured to perform a specific operation or stage, such as within a fused dot product processing pipeline. A block may include logic dedicated to tasks such as partial product generation, exponent computation, operand alignment, compression, normalization, rounding, or saturation. Each such block is implemented in hardware and may comprise combinational logic, sequential elements, multiplexers, adders, shifters, or other arithmetic and control circuitry. A block may operate in coordination with adjacent blocks to support format-specific operand handling (e.g., for FP8, BF16, or INT8 inputs) and to facilitate execution across multiple stages of a fused arithmetic operation. Unless otherwise specified, a block denotes a logically discrete and addressable hardware structure and does not imply any particular physical dimensions, geometric configuration, or fixed boundary.

FIG. 2 illustrates exponent alignment and normalization logic 200 for a block-normalized FP8 dot product operation, in accordance with various embodiments. The logic 200 operates on a plurality of FP8 operand pairs to compute intermediate product terms and normalize the accumulated result within a constrained datapath width. In some embodiments, the logic 200 may be implemented in hardware using combinational logic circuitry, such as adders, subtractors, multiplexers, shift units, and carry-save structures. The depicted components may be implemented within an execution pipeline configured for fused or partially fused multiply-accumulate operations using low-precision inputs and higher-precision accumulation.

The operand terms to be accumulated are represented by the array 205 of partial product entries, corresponding to individual bitwise multiplications of input significands. In the depicted example, four products (e.g., A0×B0 through A3×B3) are calculated, with each product involving the multiplication of a 4-bit operand a[3:0] by another 4-bit operand b[3:0]. A partial product array of operands 205 is formed for each dot product, such that each row of operands 205 represents one of the four partial products (e.g., a[3]×b[3:0] through a[0]×b[3:0]), with individual bit positions aligned such that the least significant bits appear at the rightmost positions. Thus, each row of operands 205 represents one of the FPS multiplicative terms (e.g., A0×B0 through A3×B3), with individual bit positions aligned such that the least significant bits appear at the rightmost positions. In the depicted configuration, partial products from each pairwise FP8 multiplication are zero-extended or aligned to reflect positional significance prior to summation. The array 205 is provided as input to a 4:2 compressor 210, which performs a carry-save accumulation across the operand rows. The compressor 210 embodies combinational compressor logic configured to reduce multiple aligned input operands into two intermediate vectors representing sum and carry outputs, without immediately resolving carry propagation.

The outputs of the 4:2 compressor 210 are resolved by an 8-bit carry-propagate adder 215. The adder 215 performs a 2:1 summation of the compressor outputs to produce a combined intermediate significand value that represents the unnormalized result of one of the FP8 multiplications. In some implementations, the adder 215 comprises fixed-width arithmetic logic optimized for low-latency carry resolution. The resulting value is provided to a normalization shifter 220, which includes normalization shift logic configured to align the significand in accordance with its leading bit position. The normalization shifter 220 also accommodates subnormal representations (e.g., denorms) by conditionally shifting based on the result magnitude. In some embodiments, the normalization shifter 220 is implemented using a barrel shifter or similar circuit capable of left-shifting by a variable amount determined at runtime.

A final one-bit shift operation is selectively performed by shift unit 225, which may apply a one-position alignment correction to the normalized result. This stage allows fine-grained rounding adjustment or exponent reconciliation where needed. The output of shift unit 225 may then be combined with an addend term (e.g., a pre-accumulated FP32 value) in a subsequent summation stage (not shown).

To determine the correct normalization shift amount, the logic 200 includes a pair of leading zero counters (LZCs) 240 and 245, which respectively analyze intermediate sum and carry terms produced by compressor 210. Each LZC 240, 245 detects the number of leading zeros in its operand, and their results are combined by a 2:1 adder 250 to produce a shift control value. This shift control value reflects the number of leading zeros to be removed via normalization, and is forwarded to normalization shift logic 220 to adjust the position of the most significant bit.

In parallel with the significand path, exponent alignment logic is applied to maintain consistent scaling. In particular, a group of input exponent values 230 is combined using a 3:1 adder 235, which may incorporate bias or scaling offsets depending on encoding format. The resulting exponent sum is adjusted by a 2:1 subtractor 260, which determines the difference between the maximum exponent and a reference or effective exponent value associated with the accumulated result. This exponent difference is selectively incremented by incrementer 270, depending on whether rounding or normalization logic introduces an effective carry-out or shift-left operation. The final adjusted exponent is then forwarded along with the normalized significand result to generate the completed dot product output.

The exponent alignment and normalization logic 200 enables efficient block normalization within a constrained datapath width, such as 32 bits, while preserving numerical significance across accumulated FP8 product terms. By separating the exponent and leading-zero count paths, the logic 200 adapts to cancellation effects and dynamic operand ranges, mitigating precision loss while avoiding reliance on wide internal accumulators.

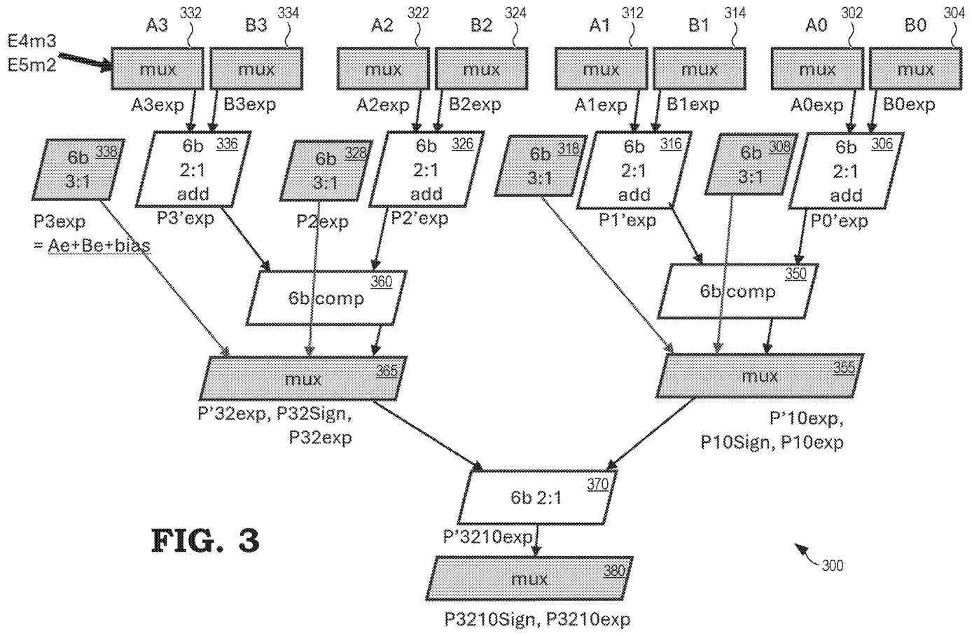

FIG. 3 illustrates an exponent selection pipeline 300 for determining a maximum corrected exponent across multiple FP8 multiplicative terms, in accordance with various embodiments. In various embodiments, the exponent selection pipeline 300 is implemented in hardware using fixed-width arithmetic logic, multiplexers, comparators, and control circuitry configured to identify the dominant exponent value used for block normalization in a fixed-width accumulation datapath.

Each operand of the dot product is provided in a compressed floating-point format, such as E4M3 or E5M2. As used herein, E4M3 and E5M2 refer to such formats that represent 8-bit floating-point values using reduced exponent and significand widths. In the E4M3 format, each value comprises 1 sign bit, 4 exponent bits, and 3 significand bits; in the E5M2 format, each value comprises 1 sign bit, 5 exponent bits, and 2 significand bits. These formats provide a compact representation of real numbers for low-precision arithmetic workloads, enabling efficient storage and processing in matrix-oriented operations such as dot products. Both formats support subnormal values and are typically used in hardware-accelerated machine learning inference.

Multiplexers 302, 304, 312, 314, 322, 324, 332, and 334 respectively select an exponent encoding format for each operand A0 through A3 and B0 through B3. In some embodiments, each of multiplexers 302, 304, 312, 314, 322, 324, 332, and 334 is a 2:1 multiplexer configured to select between E4M3 and E5M2 representations, such as based on an instruction-level format control or a tile-level encoding flag. The selected exponent values are forwarded as respective signals A0exp through B3exp.

Each operand pair (Ai, Bi) is processed to compute a corresponding product exponent term. For each of the four FP8 products, a respective 3:1 adder—adders 308, 318, 328, and 338—combines the input exponents with a fixed bias value. In certain scenarios and implementations, these adders 308, 318, 328, 338 may be implemented as 6-bit arithmetic units, with two operand inputs drawn from Ai and Bi and an optional third operand used for constant bias insertion. The resulting intermediate values, labeled P0exp through P3exp, reflect the raw product exponents.

To correct or align the exponent terms, each product exponent value is passed through a corresponding 2:1 adder 306, 316, 326, 336, which produce corrected product exponents labeled P0″exp through P3′exp. These corrected product exponents incorporate shift adjustments or pre-alignment for subsequent normalization. Each of these corrected exponents is then paired for comparison.

A first 6-bit comparator 350 compares P0′exp and P1′exp, and a second comparator 360 compares P2′exp and P3′exp. The respective outputs of these comparisons control multiplexers 355 and 365, each of which selects the greater of each exponent pair and propagates the corresponding exponent and sign information. The multiplexer 365 produces the selected output P′32exp, P32exp, and P32Sign, while the multiplexer 355 produces P′10exp, P10exp, and P10Sign. In some embodiments and scenarios, each multiplexer includes logic to propagate a selection bit, an overflow signal, or an associated status flag alongside the chosen exponent.

The results of the two subtrees (the subtrees respectively handling the A0B0 and A1B1 or A2B2 and A3B3 multiplicands) are combined via a 2:1 adder 370 and a multiplexer 380. The adder 370 receives P′32exp and P′10exp as inputs and determines a final corrected exponent P′3210exp. This stage may additionally reconcile minor rounding or alignment discrepancies, or prioritize selection according to signed magnitude. The output of adder 370 is provided to multiplexer 380, which selects and forwards the final exponent P3210exp and associated sign P3210Sign for use in subsequent datapath stages, such as normalization shifter 220 of FIG. 2.

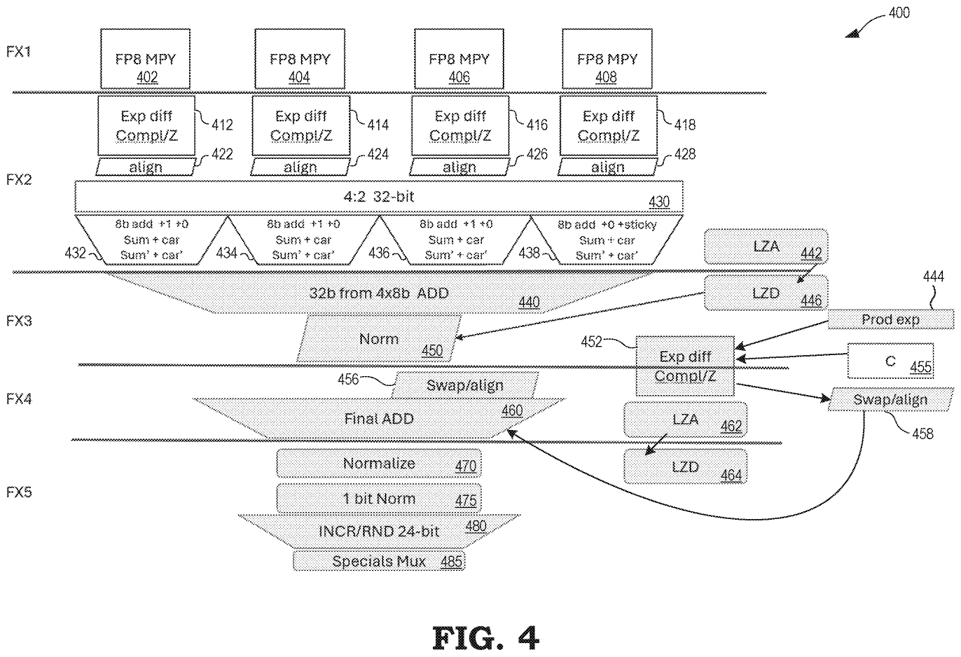

FIG. 4 illustrates a processing pipeline 400 for block-normalized dot product accumulation using FP8 inputs and a fused FP32 addend, in accordance with various embodiments. The pipeline 400 comprises a series of hardware stages configured to perform low-precision multiplications, exponent-aligned accumulation, normalization, and floating-point addition, followed by final rounding and result generation. Each stage is shown with representative functional blocks across a sequence of five pipeline cycles, labeled FX1 through FX5.

In stage FX1, four FP8 multiplier units 402, 404, 406, and 408 (each of which operates substantially identically to exponent alignment and normalization logic 200 of FIG. 2) each receive a pair of low-precision operands corresponding to a vector-scalar dot product term. As described elsewhere herein with respect to exponent alignment and normalization logic 200, each multiplier is configured to output a product value along with associated exponent data. The corresponding exponent processing blocks 412, 414, 416, and 418 each implement complement and zero-detection logic (Compl/Z) to identify operands that may need to be dropped due to alignment shifts or complemented for effective subtraction. Output values from each Compl/Z block are forwarded to respective alignment circuits 422, 424, 426, and 428, which perform bit shifting of the product significands based on exponent differences relative to a block-normalized exponent reference.

In stage FX2, aligned product terms are fed into a multi-operand compression tree that accumulates the partial products using a 4:2 carry-save adder 430. Four intermediate accumulation paths are shown in blocks 432, 434, 436, and 438, each comprising 8-bit adders with sum and carry outputs as well as speculative rounding control (e.g., “+1+0” or “+sticky”) to support high-throughput arithmetic behavior. Sum and carry vectors are accumulated in parallel and propagated for resolution in the subsequent stage.

In stage FX3, the intermediate sum and carry vectors are resolved into a single 32-bit result via logic block 440. This result represents the aggregated output of four FP8 dot product terms. The 32-bit value is provided to a normalization circuit 450, which in conjunction with swap/align block 456 aligns the most significant bit of the result using left-shift logic. The shift amount is determined based on leading zero detection (LZD) and/or leading zero anticipation (LZA) units 442 and 446, which receive the 32-bit result and provide control signals to drive the normalization shift. In parallel, a product exponent reference 444 is used to support downstream alignment of an addend operand.

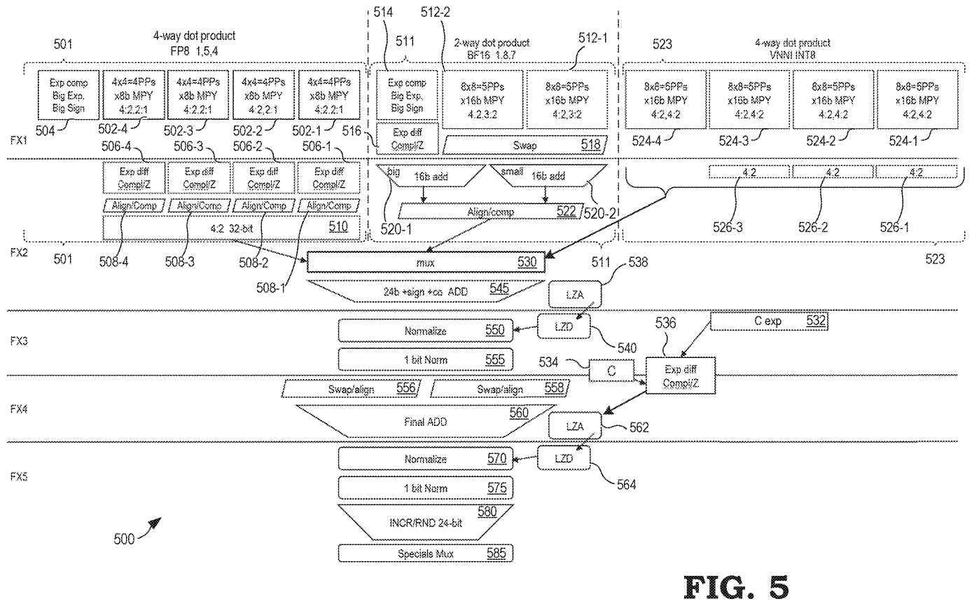

The addend operand C 455 represents an FP32-format value provided for accumulation, such as a running sum or bias value. As used herein, operand C 455 (and similar operand 534, discussed below with respect to FIG. 5) represents a secondary operand in the fused dot product operation (typically corresponding to an accumulation or bias value to be added to the result of a primary computation), with the primary operands in each dot product term being the multiplicand pairs (e.g., the vector elements A, and scalar elements Bᵢ) that are multiplied, aligned, and/or reduced prior to summation with the secondary operand.

In the depicted example, the exponent of addend C 455 is compared against the block-normalized product exponent 444 using exponent difference and complement/zero-detection logic 452. This block outputs control signals to a swap and align circuit 458, which right-shifts the C operand and conditionally complements it to align with the normalized product sum. As shown, both the C operand and the product exponent are input to block 452, and the result of the comparison is used to configure how C is aligned in block 458.

Stage FX4 receives both the normalized dot product output and the aligned addend operand. The aligned addend is forwarded from swap/align block 458 to a final adder 460, which performs full-width addition of the two values. This addition may be signed and is performed in fixed-point or intermediate floating-point format prior to post-processing. In some embodiments, LZA 462 and LZD 464 logic may be reused to anticipate or detect any additional shifts needed in the final result.

In stage FX5, the final result is passed through normalization and rounding logic. Block 470 performs normalization shifting to adjust the significand based on the result of the addition in block 460. A one-bit normalization stage 475 corrects for possible LZA overshoot or undershoot. Block 480 performs rounding or incrementing of the normalized value to generate a final 24-bit result, consistent with IEEE FP32 significand width. A special-case multiplexer 485 selects alternate outputs in the case of detected zeros, infinities, NaNs (special values used to represent results of undefined or unrepresentable operations), or underflow.

As depicted, the processing pipeline 400 supports efficient accumulation of FP8 dot product terms into a normalized FP32 result, while minimizing the overhead of wide intermediate datapaths. The illustrated architecture enables fused operations by combining normalization and addition logic in a streamlined sequence and by using block exponent selection across the input terms to reduce shifting overhead. The inclusion of the addend C 455 enables fused multiply-accumulate (FMA) semantics, with consistent normalization behavior maintained across cycles FX3 through FX5.

FIG. 5 illustrates a processing pipeline 500 configured to perform fused dot product computations using multiple alternative operand format paths 501, 511, 523, including a four-way dot product using FP8 inputs (501), a two-way dot product using BF16 inputs (511), and a four-way dot product using INT8 inputs (523). The pipeline is structured across five pipeline stages—FX1 through FX5—each representing a distinct phase in the operand processing and accumulation flow. While each of the operand format paths 501, 511, 523 includes dedicated logic tailored to the structure and alignment needs of its respective format, all three alternative paths selectably feed into a shared accumulation backend that includes common arithmetic and normalization circuitry.

In the illustrated embodiment, the FPS operand path 501 supports a four-way fused dot product operation in which each operand pair comprises two FP8 values, with the result being accumulated within a fixed-width datapath. The FP8 operand path 501 includes four FP8-by-FP8 multipliers 502-1 through 502-4, each configured to perform a sub-byte multiplication of two 8-bit floating-point values. Internally, each FP8 operand is expanded into a 1-5-4 format, comprising one sign bit, five exponent bits (including bias correction), and four effective significand bits (including the implied leading one), providing a compact yet sufficiently expressive encoding for low-precision inference workloads. Each multiplier 502-i operates on 4-bit significands, producing partial products in a 4 b×4 b configuration, with the resulting products aligned based on the corresponding product exponent.

The FP8 operand path 501 further includes shared exponent and sign preprocessing logic 504, which generates product exponents by summing the respective input exponents of each operand pair and subtracting the FP8 bias value. The resulting product exponents are passed to a set of exponent comparator and selection units 506-1 through 506-4, each of which participates in a hierarchical binary tree structure for determining the maximum exponent among the four products. This maximum exponent value is used to block-normalize the intermediate products, aligning their magnitudes for consistent accumulation while preserving up to 29 bits of precision in a 32-bit-wide dataflow.

Following exponent selection, each of the four intermediate product values is routed through corresponding alignment and conditional complement blocks 508-1 through 508-4, which both determine the exponent difference between each product exponent and the maximum selected exponent, and shift the corresponding significands to right-align them within the available bit window. If the accumulation is an effective subtraction (e.g., due to differing operand signs or control conditions), the smaller operand may be conditionally complemented using bitwise inversion logic to support two's complement-style arithmetic. These alignment and complement operations are implemented in hardware using shifters, adders, and control logic configured to detect operand relationships and enforce consistent normalization behavior.

The aligned and conditioned partial products are compressed using a shared 4:2 compressor 510. In certain embodiments, the compressor 510 utilizes a multi-stage compressor structure, beginning with one or more intermediate stages (not separately shown). As depicted, the compressor 510 is configured to reduce four aligned operand rows into two intermediate vectors representing sum and carry values, which may then be forwarded into a post-compression accumulation stage. In some embodiments, the compressor 510 is implemented using a combination of carry-save adder (CSA) logic and fast arithmetic carry-path optimization circuits, facilitating low-latency combination of multiple high-precision partial products within a constrained datapath width.

Alternatively, the BF16 operand path 511 supports two-way dot product computation using inputs in the bfloat16 (BF16) format or, in some implementations, an equivalent FP16 representation. Each operand pair comprises two 16-bit floating-point values—each with 1 sign bit, 8 exponent bits, and 7 significand bits (in the case of BF16)—allowing for a wider dynamic range and precision than FP8 inputs while still maintaining sub-32-bit data width. The BF16 operand path 511 includes two dedicated multipliers 512-1 and 512-2, each configured to compute a BF16-by-BF16 product. These multipliers may be implemented using partial-width multiplier arrays and pipelined exponent handling circuits to accommodate the increased operand width relative to FP8 or INT8 inputs.

The input operands for the multipliers are processed by exponent combination logic 514, which (in conjunction with exponent comparator and selection unit 516) computes a summed product exponent for each BF16 operand pair. This exponent combination accounts for the bias inherent to the BF16 format and may also include handling of subnormal inputs or denormalized values. The resulting product exponents are compared and ranked via swap logic 518, which is configured to identify the larger of the two product exponents and reorder the operands accordingly to ensure consistent alignment behavior in downstream logic. Once the operand ordering is established, each product exponent is forwarded to a respective exponent difference adder—blocks 520-1 and 520-2—configured to calculate the delta between each product exponent and the selected maximum exponent determined during earlier comparison stages.

The adders 520 generate shift values that reflect how much each corresponding significand must be right-shifted to align with the larger-magnitude operand prior to accumulation. If the computed exponent difference exceeds a predefined alignment threshold, the associated operand may be masked or bypassed to preserve accumulator dynamic range. The outputs of the exponent difference adders serve as control inputs to a subsequent alignment and comparison stage. The aligned operand processing is performed by block 522, which receives the significands and corresponding shift values and applies right-shift alignment, conditional complementation, or suppression based on the calculated exponent deltas. In certain embodiments, this aligned/comp block 522 may also implement sticky-bit tracking to preserve rounding precision in the case of shifted-out bits.

After alignment, block 522 combines the adjusted significands into a partial sum suitable for delivery to the shared accumulation path. The output may be formatted as a 24-bit or 32-bit value, depending on implementation requirements, and is compatible with the shared 24 b+sign+co adder used across operand formats. The resulting value is forwarded via multiplexer 530 into the common accumulation backend.

The BF16 operand path 511 thus provides a wider dynamic range and greater significand precision than the FP8 path 501, while leveraging the same backend accumulation, normalization, and rounding infrastructure to minimize area and latency overhead.

The alternative INT8 operand path 523 supports a four-way dot product operation utilizing vectorized 8-bit integer inputs and 16-bit multiplicands in a configuration consistent with VNNI-style (Vector Neural Network Instructions) workloads. This operand path includes four INT8-by-INT8 multipliers 524-1 through 524-4 (collectively referenced as multipliers 524), each configured to perform low-precision integer multiplications followed by optional widening and accumulation. In various embodiments, each multiplier 524 supports fused operations such as INT8×INT8→INT32 or INT8×INT8→FP32, depending on the surrounding datapath configuration, such that the four multipliers receive vectors of 8-bit signed or unsigned integers and generate multi-bit partial products.

The output of each multiplier 524 includes multiple partial product terms, which are forwarded to a multi-stage compression tree. In the depicted embodiment, partial products from the four multipliers are grouped and reduced through three corresponding 4:2 compressors 526-1, 526-2, and 526-3 (collectively referenced as compressors 526). Each compressor 526 receives up to four aligned operand rows and produces two output vectors representing a sum and carry, respectively. These compressors 526 are implemented using carry-save logic to eliminate intermediate carry propagation and to allow for accumulation of multiple low-precision operands without loss of dynamic range. Following compression, the sum and carry vectors are passed to the shared accumulation datapath via multiplexer 530.

Each of the three format-specific paths—501, 511, and 523—feeds its respective output into a multiplexer 530, which selects between the pre-aligned and pre-compressed dot product results based on the active operand format and instruction type. The selected value is routed into a shared 24-bit accumulation datapath that includes an adder 545 with sign extension and carry-out support. In some embodiments, the adder 545 is configured to accept either a 24-bit or 32-bit input. Each operand datapath includes logic to detect overflow conditions (e.g., via carry-out signaling in adder stages such as 545 and 560) and to track sticky bits generated during alignment and compression (e.g., via align/comp blocks 508 and compressor 510 for operand datapath 501, align/comp block 522 for operand datapath 511, or compressors 526 for operand datapath 523) for downstream rounding decisions.

The output of adder 545 is forwarded to normalization block 550, which includes circuitry for left-shifting the result in accordance with leading zero count detection. To support dynamic normalization across operand formats, the normalization block 550 incorporates both leading-zero anticipation (LZA) logic 538 and leading-zero detection (LZD) logic 540, which are configured to estimate the number of leading zeros in the accumulated result and apply shift correction within the logic embodied by normalization block 550. This normalization provides adjustment of the output's exponent in floating-point modes (e.g., FP8 and BF16) and allows for range extension in fixed-point or integer modes (e.g., INT8).

The normalized output from block 550 is forwarded to one-bit normalization block 555, which selectively applies a single-bit left shift to correct potential overshoot introduced by LZA prediction error. This output is directed to swap/alignment logic 556, which prepares the accumulated dot product result for combination with a separate addend operand such as a fused constant or prior accumulation. In parallel, block 558 receives the addend operand C via a stored operand value 534; its corresponding exponent 532; and a comparator block 536, which determines the exponent difference between the normalized dot product result and the C operand. In certain embodiments and scenarios, the C operand may additionally include sticky-bit, rounding, and gating signals.

Exponent information from the comparator block 536 is provided to a second LZA block 562 and LZD block 564, which operate in conjunction with a final adder 560 to characterize the output of the fused addition and enable proper normalization by normalization block 570. The result of this fused add is processed through a final normalization pipeline including a full normalization stage 570, a one-bit adjustment stage 575 to correct for any LZA overshoot, and rounding logic 580 configured for 24-bit increment and rounding operations. Depending on the format and dynamic conditions of the result, individual stages may be bypassed or act as pass-through operations. Final result selection and special-case handling (e.g., INF/NaN propagation or INT32 saturation) is performed by multiplexer 585.

The outputs of swap/alignment blocks 556 and 558 are provided to a final adder 560, which performs summation of the normalized dot product with the aligned addend value. The output of final adder 560 is then provided to normalization logic 570, which adjusts the result's significand based on updated exponent alignment, including any shift correction indicated by LZA logic 562 or LZD logic 564. In some embodiments, the normalization logic 570 applies barrel shifting or staged left-shifting logic to align the result with the correct exponent scale.

LZA logic 562 uses the two inputs to adder 560 to determine where the leading 1 of the sum will be, but in certain scenarios such determination can under- or over-estimate that placement by one bit. Therefore, a one-bit final shift correction is optionally applied in normalization block 575, which allows post-rounding alignment correction. For example, normalization block 575 shifts the output of normalization logic 570 one bit to the left if its most significant bit is a zero. The output is then passed to a rounding unit 580, which applies a rounding mode (e.g., round-to-nearest-even, truncation, or stochastic rounding) and produces a properly rounded 24-bit output, suitable for use as, e.g., an FP32-format significand. Finally, in the depicted embodiment a special-case multiplexer 585 is used to override the final result with a zero, infinity, or NaN condition if such was flagged earlier in the processing pipeline. These special-case values ensure IEEE 754 compliance in the case of exceptional arithmetic behavior or undefined operations. The result of multiplexer 585 constitutes the final dot product output for the selected operand format.

The shared post-accumulation logic of FIG. 5 provides enhanced flexibility to support multiple operand formats (via alternative operand datapaths 501, 511, 543) with minimal duplication of logic, such that BF16 and INT8 computations reuse the same backend pipeline stages for normalization, rounding, and final accumulation. This use of format-selective multiplexing (e.g., via multiplexer 530) and independently configurable alignment stages enables efficient hardware sharing without compromising operand-specific accuracy requirements.

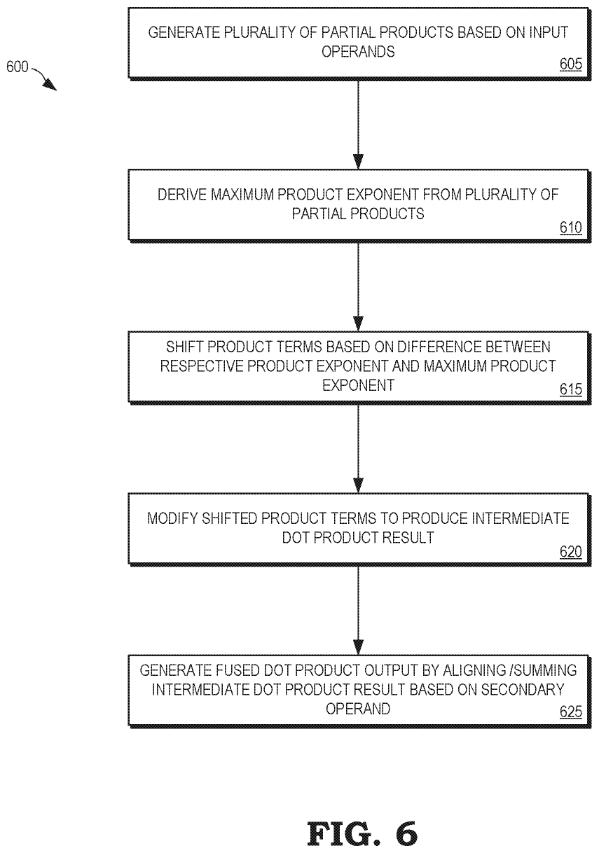

FIG. 6 illustrates an operational flow diagram representing a fused dot product routine 600 implemented by a processing system, in accordance with various embodiments. The routine may be performed, for example, by implementations of a hardware processor such as CPU 101 (with reference to FIG. 1), and is designed to accommodate multiple operand formats while performing alignment-sensitive accumulation with support for precision management, normalization, and rounding.

The routine begins at block 605, in which the processing system generates a plurality of partial products based on two or more input operands. Such operations may, in certain embodiments, involve one or more multiplier arrays capable of handling FP8, BF16, or INT8 inputs, with format-specific logic generating multiple intermediate products in parallel. The routine proceeds to block 610.

At block 610, the processing system derives a maximum product exponent from the set of generated partial products. This value represents the largest magnitude exponent among the group and may be determined using comparator logic or exponent combination units configured to examine the exponents of each partial product. In some embodiments and scenarios, this exponent corresponds to the product with the greatest numeric magnitude in order to facilitate alignment of the remaining terms. The routine proceeds to block 615.

At block 615, the processing system shifts each of the product terms based on a difference between its own exponent and the maximum product exponent. Shift control signals are generated based on the calculated exponent deltas, and operand gating may be applied to discard or suppress low-significance terms that exceed an alignment threshold. As discussed in greater detail elsewhere herein, in certain embodiments alignment may be implemented via shift logic coupled with sticky bit tracking to preserve rounding precision for shifted-out bits. The routine proceeds to block 620.

At block 620, the processing system modifies the shifted product terms to produce an intermediate dot product result. Depending on operand format and implementation, such modifications may include compression using one or more multi-operand compressors, normalization of leading bits based on leading-zero anticipation (LZA) or detection (LZD), conditional complementing of terms based on control signals, and truncation of lower-order bits for precision control. The result is a format-harmonized partial sum that is compatible with subsequent accumulation and output stages. The routine proceeds to block 625.

At block 625, the processing system generates the final fused dot product output by aligning and summing the intermediate dot product result with a secondary operand. The secondary operand may represent a previous accumulation result (e.g., FP32 or INT32 value) or a bias value injected for quantization offset or scaling adjustment. Alignment circuitry ensures that the exponent scale of the intermediate result matches that of the secondary operand, enabling a properly fused final accumulation. In certain embodiments and scenarios, the resulting output is forwarded to additional logic stages/circuitry for final normalization, rounding, saturation, or special-case handling.

In some embodiments, the apparatus and techniques described above are implemented in a system including one or more integrated circuit (IC) devices (also referred to as integrated circuit packages or microchips), such as the processing system 100 described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc.

This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method comprising:
shifting a set of product terms based on a maximum product exponent derived from multiple partial products;
modifying the shifted product terms to produce an intermediate dot product result; and
aligning and summing the intermediate dot product result using a secondary operand to generate a fused dot product output.

2. The computer-implemented method of claim 1, wherein modifying the shifted product terms to produce the intermediate dot product result comprises one or more operations selected from a group that includes compressing, normalizing, conditionally complementing, or truncating at least one of the shifted product terms.

3. The method of claim 2, wherein truncating at least one of the shifted product terms comprises discarding one or more least significant bits of the at least one shifted product term.

4. The method of claim 1, wherein deriving the maximum product exponent comprises selecting a product exponent associated with a largest-magnitude result among multiple format-specific partial products.

5. The method of claim 1, wherein shifting the set of product terms comprises shifting each product term based on a difference between an exponent of a respective product and the maximum product exponent.

6. The method of claim 1, wherein modifying the shifted product terms comprises compressing the shifted product terms using a multi-operand compressor.

7. The method of claim 1, wherein modifying the shifted product terms comprises applying conditional complementing to at least one of the shifted product terms based on an operand sign control signal.

8. The method of claim 1, wherein modifying the shifted product terms comprises normalizing at least one of the shifted product terms based at least in part on one or more of leading-zero anticipation (LZA) or leading-zero detection (LZD).

9. The method of claim 1, further comprising selecting one of a plurality of format-specific operand paths based on a data format associated with one or more input operands, wherein each operand path of the plurality includes one or more format-specific multiplier or alignment operations, and wherein the selected operand path generates the intermediate dot product result.

10. The method of claim 9, further comprising providing the intermediate dot product result to an accumulation datapath to generate the fused dot product output, the accumulation datapath being common to the plurality of format-specific operand paths.

11. The method of claim 1, further comprising:
receiving FP8-encoded operand fragments corresponding to the set of product terms and the secondary operand;
for each product term of the set of product terms, deriving a corresponding product exponent; and
selecting the maximum product exponent from among the derived product exponents.

12. The method of claim 11, wherein shifting the set of product terms based on the maximum product exponent comprises shifting a respective significand of the set of product terms by a respective shift distance that is based on a difference with the maximum product exponent.

13. A processing system comprising:
a multiplier array to generate a plurality of partial products based on two or more input operands;
comparison circuitry to derive a maximum product exponent from the plurality of partial products;
alignment circuitry to shift a set of product terms based on a difference between a respective product exponent and the maximum product exponent;
dot product processing circuitry to modify the shifted product terms to produce an intermediate dot product result; and
accumulation circuitry to align and sum the intermediate dot product result based on a secondary operand to generate a fused dot product output.

14. The processing system of claim 13, wherein to modify the shifted product terms to produce the intermediate dot product result comprises one or more operations selected from a group that includes compressing, normalizing, conditionally complementing, or truncating at least one of the shifted product terms.

15. The processing system of claim 13, wherein to derive the maximum product exponent comprises selecting a product exponent associated with a largest-magnitude result among multiple format-specific partial products.

16. The processing system of claim 13, wherein to shift the set of product terms comprises shifting each product term based on a difference between an exponent of a respective product and the maximum product exponent.

17. The processing system of claim 13, wherein to modify the shifted product terms comprises normalizing at least one of the shifted product terms based at least in part on one or more of leading-zero anticipation (LZA) or leading-zero detection (LZD).

18. The processing system of claim 13, further comprising control circuitry to select one of a plurality of format-specific operand paths based on a data format associated with one or more input operands, wherein each operand path of the plurality is configured to perform one or more format-specific multiplier or alignment operations, and wherein the selected operand path generates the intermediate dot product result.

19. The processing system of claim 13, wherein the multiplier array is further to:
receive FP8-encoded operand fragments corresponding to the set of product terms and the secondary operand;
for each product term of the set of product terms, derive a corresponding product exponent; and
select the maximum product exponent from among the derived product exponents.

20. A non-transitory computer-readable medium storing instructions that, when executed by one or more processors, manipulate the one or more processors to:
shift a set of product terms based on a maximum product exponent derived from multiple partial products;
modify the shifted product terms to produce an intermediate dot product result; and
align and sum the intermediate dot product result based on a secondary operand to generate a fused dot product output.
